(19) United States
(12) Patent Application Publication
(10) Pub. No.: US 2005/0278118 A1
(43) Pub. Date: Dec. 15, 2005

(54) Safe driving guide system using GPS

(76) Inventor: Heung-Ki Kim, Gyeonggi-do (KR)

Correspondence Address: JACOBSON HOLMAN PLLC, 400 SEVENTH STREET N.W., SUITE 600, WASHINGTON, DC, 20004, US

(21) Appl. No.: 10/922,143

(22) Filed: Aug. 20, 2004

(30) Foreign Application Priority Data
Jun. 9, 2004 (KR) 10-2004-42176

(51) Int. Cl. G01C 21/26

(52) U.S. Cl. 701/213; 701/214

(57) ABSTRACT

The present invention relates to a safe driving guide system using a Global Positioning System (GPS), which informs a driver of unexpected conditions when the unexpected conditions occur on roads throughout the nation, prevents operational errors from being generated even though location-specific road condition information is indicated between a road being traveled and some other road at the time of driving a vehicle, and provides a means for detecting a sudden start, a sudden stop, sudden deceleration or sudden acceleration in the case where the vehicle suddenly starts, stops, decelerates or accelerates, respectively, thus enabling the driver to safely drive the vehicle. For this purpose, the safe driving guide system includes a GPS satellite for transmitting the location data of a vehicle, a safe driving guide server for providing a guide message to allow the driver to safely drive the vehicle, and a safe driving guide terminal for allowing the driver to register the unexpected conditions with the safe driving guide server.

### BACKGROUND OF THE INVENTION

1. Field of the Invention

The present invention relates generally to a safe driving guide system applied to vehicles and, more particularly, to a safe driving guide system using a global positioning system, which informs a driver of unexpected conditions when the unexpected conditions occur on roads throughout the nation, prevents operational errors from being generated even though location-specific road condition information is indicated between a road being traveled and some other road at the time of driving a vehicle, and provides a means for detecting a sudden start, a sudden stop, sudden deceleration or sudden acceleration in the case where the vehicle suddenly starts, stops, decelerates or accelerates, thus enabling the driver to safely drive the vehicle.

2. Description of the Related Art

A Global Positioning System (GPS) is a system, which enables users to accurately detect the locations thereof everywhere in the world as well as in an airplane, a ship and an automobile using an artificial satellite.

As described above, the GPS is applied to various transportation means because the locations of mobile objects can be detected in real time. As an example of such application, a previously registered satellite communication navigation warning system (Korean Pat. No. 10-0415845) provides a system in which a GPS is applied to vehicles and warning of danger is provided using the locations of the moving vehicles detected in real time.

The conventional satellite communication navigation warning system includes a satellite antenna for transmitting and receiving information, which is required for navigation, to and from a plurality of GPS satellites; a satellite data transmission and reception engine for receiving information on the location of a vehicle output from the satellite antenna, compensating for calculation errors after speedily calculating information to be transmitted to the GPS satellites and performing signal transmission with the satellite antenna; a navigation information input unit for performing an input operation to receive data from Internet sites via connecting communication lines; a microprocessor for processing information required for the navigation of the vehicle, searching the data downloaded through the navigation information input unit and finding dangerous areas near the navigation area based on the data received from the satellite data transmission and reception engine according to a control state, and controlling a guide required for the navigation; a data storage unit for storing signals to be processed in the microprocessor, and inputting and outputting related data; a control unit for controlling the operational processes of the microprocessor and other components; and an output unit for outputting a voice and indication guide required for the navigation, and displaying the state of the microprocessor.

The conventional satellite communication navigation warning system constructed as described above updates location information related to dangerous areas throughout the nation, such as sharply curved roads, high-accident areas, dangerous areas having low speed limits, tunnels and frequently foggy areas, through a communication network, such as the Internet, searches for the dangerous areas located in front of a vehicle in a moving direction with reference to the current location of the vehicle provided by the GPS satellite during driving the vehicle, and outputs search results in the form of a voice message, so that the driver can be aware of the dangerous areas before encountering them.

The conventional satellite communication navigation warning system transmits road conditions, which are related to locations on roads, to driving vehicles at regular intervals so that the driving vehicles can detect the road conditions throughout the nation. However, since the conventional satellite communication navigation warning system has no provision for detecting unexpected conditions, such as unexpected traffic accidents and unexpected road construction, the conventional satellite communication navigation warning system is problematic in that drivers cannot be provided with safe driving guide for the unexpected conditions when the unexpected conditions occur on the roads of the nation.

Furthermore, in the case where location-specific road condition information, which indicates the location to which a guide message for guiding the condition of a road is output, is indicated between a road being traveled, which is a road on which a vehicle is driven, and some other road, which is located near the road being traveled, the conventional satellite communication navigation warning system is problematic in that the conventional satellite communication navigation warning system misjudges that the location-specific road condition information is indicated on the road being traveled even if the indicated location-specific road condition information corresponds to some other road, so that a wrong guide message is output, thus disturbing the safe driving of the vehicle.

For example, an overpass (road being traveled) and a ground road (some other road) overlap with each other when viewed from above, and the ground road is bent leftward and passes under the overpass. In the case where location-specific road condition information is indicated on the leftwardly bent location of the ground road, the conventional satellite communication navigation warning system misjudges that the location-specific road condition information is indicated on a road being traveled when a vehicle equipped with the conventional satellite navigation warning system is driven on the overpass, so that the satellite navigation warning system outputs a guide message, such as “there is a curved road ahead.” The reason for this is that location data included in the location-specific road condition information is composed of two-dimensional coordinates including latitude and longitude.

Accordingly, traffic accidents can occur due to the wrong guide message, and the traffic accidents can be serious if the traffic accidents occur at night.

Furthermore, since the conventional satellite navigation warning system cannot provide a means for enabling a driver to be aware of a sudden start, a sudden stop, sudden acceleration or sudden deceleration, the conventional satellite navigation warning system cannot provide an optimal safe driving guide in view of the manipulation of the vehicle by the driver.

### SUMMARY OF THE INVENTION

Accordingly, the present invention has been made keeping in mind the above problems occurring in the prior art, and an object of the present invention is to provide a safe driving guide system using a GPS, which is provided with a means for allowing drivers, who travel on roads where unexpected conditions occur, to register the types (the contents of road conditions) and locations of unexpected conditions when the unexpected conditions occur on the roads throughout the nation, so that other drivers, who travel on the roads on which the unexpected conditions have occurred after the unexpected condition information of the roads is registered, can be aware of the types and locations of the unexpected conditions before encountering them, thus enabling the drivers to safely drive vehicles.

Another object of the present invention is to provide a safe driving guide system using a GPS, in which a guide message corresponding to location-specific road condition information indicated on some other road is controlled to be prevented from being output in the case where the location-specific road condition information is indicated on some other road, which is located near a road being traveled on which corresponding vehicles are driven at the time of driving the vehicles, thus enabling drivers to safely drive the vehicles.

Still another object of the present invention is to provide a safe driving guide system using a GPS, which provides a means for detecting the driving behavior of a driver, such as a sudden start, a sudden stop, sudden acceleration and sudden deceleration, at the time of driving a vehicle, thus providing an optimal safe driving guide in view of the driving behavior of the driver.

In order to accomplish the above object, the present invention provides a safe driving guide system using a GPS, including a GPS satellite for transmitting the location data of a vehicle; a safe driving guide server for collecting location-specific road condition information that is renewed at regular intervals to allow a driver to safely drive the vehicle and location-specific road condition information that is directly registered by the driver, and integrating the two pieces of information into a single piece of location-specific road condition information, for providing processed location-specific road condition information corresponding to location-specific road condition information indicated between a road being traveled and some other road with reference to a driving direction of the vehicle so that operation errors are not generated in the case where the location-specific road condition information is indicated between the road being traveled and some other road at the time of driving the vehicle, and for providing a road condition guide message based on the location-specific road condition information; and a safe driving guide terminal for receiving the location data from the GPS satellite, and for receiving standard location-specific road condition information, the processed location-specific road condition information and the road condition guide message from the safe driving guide server, and outputting the road condition guide message based on the location-specific road condition information at the time of driving the vehicle, the safe driving guide terminal including a registration means for registering abnormal road conditions with the safe driving guide server in the case where the abnormal road conditions occur at the time of driving the vehicle.

The safe driving guide server may include a Data Base (DB) unit, the DB unit including a membership information DB for storing authentication information formed of an Identification (ID) and a password and personal information, which are registered by the driver of the vehicle; an administrator-managed location-specific road condition information DB for storing location-specific road condition information that is road condition information and is formed of a message identification code corresponding to a guide message and the location data of a road to which the guide message indicating the road conditions is output; a driver-registered location-specific road condition information DB for storing driver-registered location-specific road condition information that is road condition information directly registered by drivers and formed of a message identification code corresponding to a driver-registered location-specific road condition guide message and location data of the vehicle at the time of transmitting the location-specific road condition guide message; a standard location-specific road condition information DB for storing standard location-specific road condition information that is formed by collecting and processing the administrator-managed location-specific road condition information and the driver-registered location-specific road condition information; a processed location-specific road condition information DB for storing processed location-specific road condition information that is formed of location data of some other road and location data of the road being traveled corresponding to the location data of some other road in the case where location-specific road condition information is indicated on some other road, which is located near the road being traveled; and a road condition guide message information DB for storing a road condition guide message that corresponds to the standard location-specific road condition information to allow the driver to safely drive the vehicle.

The safe driving guide server may include a collection/processing module for collecting the administrator-managed location-specific road condition information that is stored in the administrator-managed location-specific road condition information DB and the driver-registered location-specific road condition information that is stored in the driver-registered location-specific road condition information DB, and processing the condition information to the standard road related condition information.

The safe driving guide terminal may include a GPS reception unit for receiving the location data from the GPS satellite; a data transmission and reception unit for receiving the standard location-specific road condition information, the processed location-specific road condition information and the road condition guide message, and for transmitting the driver-registered location-specific road condition information; a memory unit for the standard location-specific road condition information, the processing location-specific road condition information and the road condition guide message input that are input through the data transmission and reception unit, and storing a location-specific road condition registration guide message that is a guide message required to allow the drivers to register the location-specific road condition with the guide server; a message output unit for outputting the road condition guide message and location-specific road condition registration guide message stored in the memory unit; a data input unit for requesting output of the location-specific road condition registration guide message stored in the memory unit, and selecting a corresponding one of a plurality of output location-specific road condition registration guide messages; and a control unit for collecting a road condition display code input from the data input unit and coordinates (latitude and longitude) of the road on which the vehicle is located, and generating the driver-registered location-specific road condition information when the road condition display code is selected, and for controlling the generated driver-registered location-specific road condition information to be transmitted to the guide server through the data transmission and reception unit.

The data transmission and reception unit may be a wireless data transmission and reception unit for wirelessly transmitting and receiving the data.

The data transmission and reception unit may be a serial communication unit for connecting with an Internet accessible Personal Computer (PC) to function as interface to allow the data to be uploaded or downloaded, and the safe driving guide terminal may include a power supply unit for receiving an Alternating Current (AC) power of 220 V to supply power to the safe driving guide terminal through the power supply unit when the serial communication unit is connected to the Internet-accessible PC.

The safe driving guide terminal may include a driving distance/speed detection module, the memory the may include messages warning of a sudden start, a sudden stop, sudden acceleration and sudden deceleration, and the driving distance/sped detection module may divide a range of 0 to 160 km/h into 36 speed ranges, classify the 36 speed ranges in such a way that speed ranges 0 to 8 are set to a low speed range, speed ranges 9 to 22 are set to a middle speed range and speed ranges 23 to 36 are set to a high speed range, the low, middle and high speed ranges include speed range table including critical speed values, convert the location data (latitude and longitude) of the vehicle, input through the GPS reception unit at regular intervals, into a speed (km/h), determine the increases and decreases of converted successive speed values input at regular intervals, convert the converted successive speed values into speed ranges, arranges the speed ranges in groups of five successive speed ranges, sequentially repeat a calculation in which a previous speed range is subtracted from a next speed range, determine that the vehicle was suddenly started or accelerated if a sum of the calculated values is larger than a critical speed value corresponding to the low speed range, the middle speed range or the high speed range, determine that the vehicle was suddenly stopped or decelerated if the sum of the calculated values is smaller than the critical speed value corresponding to the low speed range, the middle speed range or the high speed range, and control to allow a corresponding one of sudden start, sudden stop, sudden acceleration and sudden deceleration warning messages stored in the memory unit to be output.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a system configuration diagram schematically showing a safe driving guide system using a GPS according to the present invention;

FIG. 2 is a block diagram showing the core components of a safe driving guide server constituting a part of the safe driving guide system of FIG. 1;

FIG. 3 is a block diagram showing the core components of a safe driving guide terminal constituting a part of the safe driving guide system of FIG. 1;

FIG. 4 is a perspective view showing the appearance of the safe driving guide terminal constituting a part of the safe driving guide system of FIG. 1; and

FIG. 5 is a view showing a process of performing safe driving when location-specific road condition information is indicated between a road being traveled and some other road.

### DESCRIPTION OF THE PREFERRED EMBODIMENTS

The construction and operation of an embodiment of the present invention are described in detain with reference to the attached drawings below.

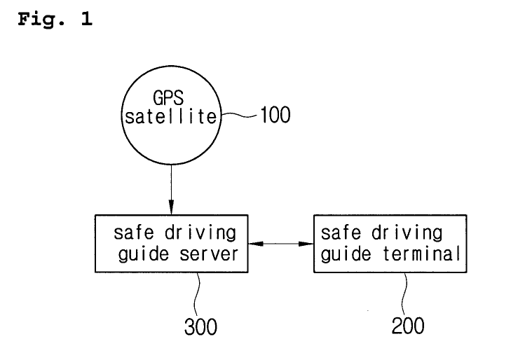

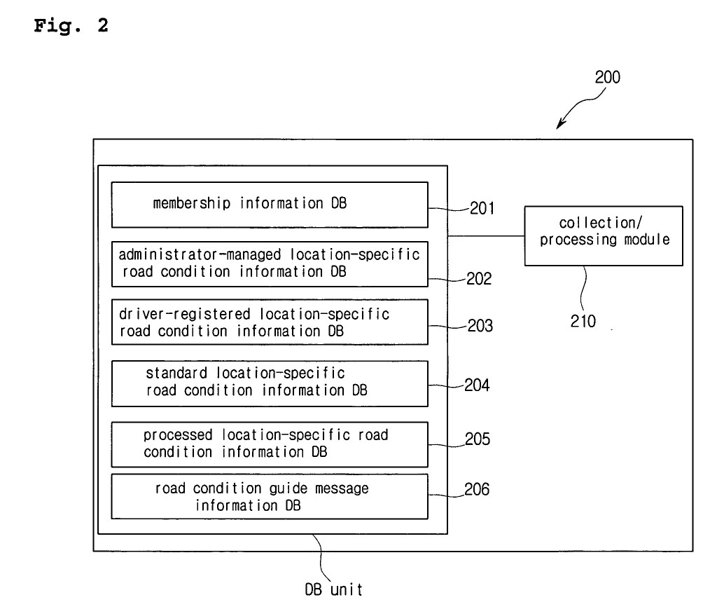

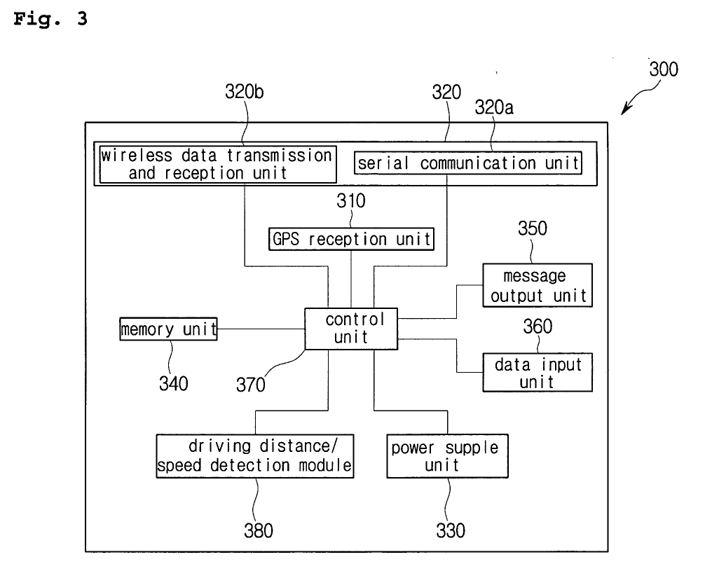

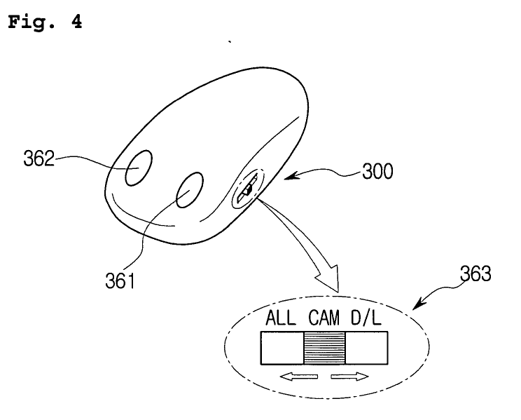

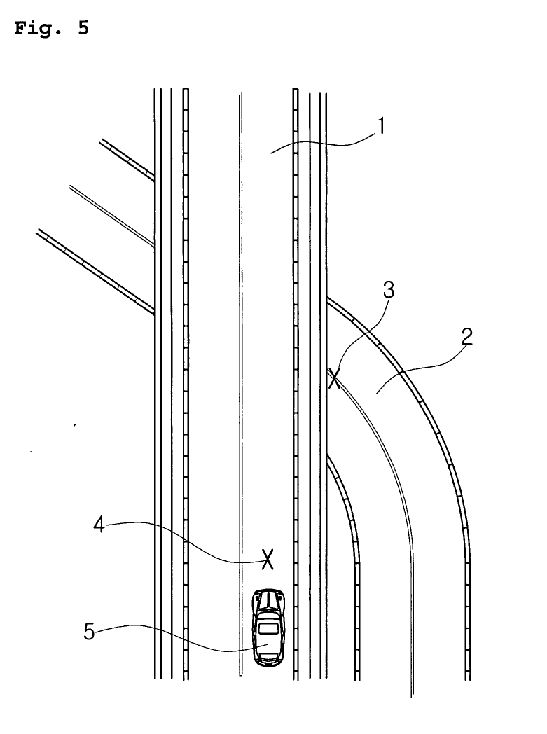

FIG. 1 is a system block diagram schematically showing a safe driving guide system using a GPS according to the present invention. FIG. 2 is a block diagram showing the core components of a safe driving guide server constituting a part of the safe driving guide system of FIG. 1. FIG. 3 is a block diagram showing the core components of a safe driving guide terminal constituting a part of the safe driving guide system of FIG. 1. FIG. 4 is a perspective view showing the appearance of the safe driving guide terminal constituting a part of the safe driving guide system of FIG. 1. FIG. 5 is a view showing a process of performing safe driving when location-specific road condition information is indicated between a road being traveled and some other road.

As shown in the drawings, the safe driving guide system using a GPS according to the present invention is equipped with a road condition type-selecting button 361 and a set button 362, which are a data input unit 360, on the appearance of a safe driving guide terminal 300 installed inside a vehicle so that a driver, who travels on a corresponding road, transmits location-specific road condition information, such as traffic accidents unexpectedly occurring on the road at the nation or unexpected road construction, to a safe driving guide server 200.

In this case, the road condition type-selecting button 361 is a button to allow the driver to select the type of unexpected road conditions suddenly occurring on a road being traveled. When the driver presses the road condition type-selecting button 361 at the location on which an unexpected accident occurs, a control unit 370 extracts a location-specific road condition registration guide message from a memory unit 340, and audibly outputs the extracted condition guide message through a message output unit 350. In this case, each location-specific road condition registration guide message includes a message identification code, which is an identification code corresponding to a corresponding location-specific road condition registration guide message.

Output registered location-specific road condition guide messages are classified into a road accident list, a road condition list and a weather-related list. Various voice messages stored in the lists are sequentially output at the time of pressing the road condition type-selecting button 361. For example, messages corresponding to the road accident list, such as “this is a deceleration area due to a traffic accident,” “this is a busy traffic area due to a traffic accident” and “this is a traffic controlled area due to a traffic accident,” are sequentially output whenever the road condition type-selecting button 361 is pressed.

In the case where a corresponding one of the messages is output, the control unit 370 detects the location-specific road condition registration guide message output at the time of pressing the set button 362 if the driver presses the set button 362, and generates driver-registered location-specific road condition information by collecting the message identification code included in the location-specific road condition registration guide message and the location data of the vehicle (the coordinates of the road) input through a GPS reception unit 310. The control unit 370 transmits the generated driver-registered location-specific road condition information to the safe driving guide server 200 through a wireless data transmission and reception unit 320a.

The safe driving guide server 200 stores the transmitted driver-registered location-specific road condition information in a driver-registered location-specific road condition information DB 203. At the same time, the safe driving guide server 200 collects location-specific road condition information managed by an administrator and stored in an administrator-managed location-specific road condition information DB 202 and the driver-registered location-specific road condition information stored in the driver-registered location-specific road condition information DB 203, processes the collected road condition information to standard location-specific road condition information, and stores the standard location-specific road condition information in a standard location-specific road condition information DB 204.

Road condition guide messages corresponding to the standard location-specific road condition information, which allows the driver to safely drive the vehicle, are stored in a road condition guide message information DB 206.

Thereafter, the safe driving guide server 200 transmits the standard location-specific road condition information stored in the standard location-specific road condition information DB 204 to all vehicles that are equipped with the safe driving guide terminals 300 of the present invention, and controls the standard location-specific road condition information to be stored in the memory units 340 of safe driving guide terminals 300, thus enabling drivers, who travel on corresponding areas, to previously detect road conditions unexpectedly occurring on roads and to safely drive the vehicles.

Furthermore, in the case where an unexpectedly occurring road condition does not correspond to the road accident list but correspond to the road condition list or weather-related list, the standard location-specific road condition information, which has been processed as described above, is transmitted to all vehicles equipped with the safe driving guide terminals 300 of the present invention if each of the drivers presses the road condition type-selecting button 361 until the guide message of a corresponding list is output.

In this case, the guide messages corresponding to the road condition list include “this is a bottleneck area,” “this is a sharply curved road,” “this is a steep downhill grade,” “this is a slippery area” and “this is a steep uphill grade.” The guide messages corresponding to the weather-related list include “this is a foggy area” and “this is an icy road (or thin icy road).” Additionally, other lists may include a list related to speed detection cameras that are installed beside the roads throughout the nation, and lists related to, for example, resting areas, school zones, gas stations, areas passable only by registered vehicles, and playground zones.

The location-specific road condition information and the standard location-specific road condition information are transmitted and received between the safe driving guide server 200 and the safe driving guide terminal 300 in such a way that the safe driving guide terminal 300 is connected to an Internet-accessible PC using a serial port, and accesses an web site managed by the safe driving guide server 200 of the present invention through the PC using an ID and a password constituting authentication information stored in a membership information DB 201. For this purpose, a serial communication unit 320b is provided in the safe driving guide terminal 300 and connected to the Internet-accessible PC, so that various types of data including the location-specific road condition information and the standard location-specific road condition information are transmitted and received. In this case, a mode button 363 placed on a side of the safe driving guide terminal 300 is located at D/L at the time of downloading data from the safe driving guide server 200.

In this case, a power supply unit 330 for receiving an AC power of 220 V is provided in the safe driving guide terminal 300, thus supplying power to the safe driving guide terminal 300 to allow the various types of data to be transmitted and received.

Furthermore, in the case where location-specific road condition information that indicates a location, to which a guide message for guiding the condition of a road is output, is indicated between a road being traveled, on which the vehicle is driven at the time of driving a vehicle, and some other road, which is located near the road being traveled, the safe driving guide terminal 300 is controlled to prevent misjudgment, so that the guide message is not output, thus enabling the driver to safely drive the vehicle.

Referring to FIG. 5, an overpass (road being traveled) 1 and a ground road (some other road) 2 overlap with each other when viewed from above, and the ground road 2 is bent leftward and passes under the overpass 1 at a location. Accordingly, in the case where location-specific road condition information 3 is indicated on the leftwardly bent location of the ground road 2, the memory unit 340 stores processed location-specific road condition information 4 corresponding to the location-specific road condition information 3 to prevent the safe driving guide terminal 300 from outputting a guide message due to misjudgment. Accordingly, the control unit 370 of the safe driving guide terminal 300 mounted on the driving vehicle 5 detects the processed location-specific road condition information 4 by matching the location data of the vehicle, input through the GPS reception unit 310, with the memory unit 340 first.

In this case, the processed location-specific road condition information 4 is formed of the location data of the location-specific road condition information indicated on the ground road 2 that is some other road, and the location data of the overpass 1, which is the road being traveled, corresponding to the location data of the location-specific road condition information indicated on the ground road 2. The control unit 370 detects the location data of some other road 2 corresponding to that of the road being traveled 1, and prevents a guide message corresponding to the location-specific road condition information of some other road 2 from being output if the location-specific road condition information of some other road 2 is searched for. For this purpose, the data storage structure of the processed location-specific road condition information 4 is formed in such a way that the location data of some other road 2 is located under the location data of the road being traveled 1, and the control unit 370 is programmed in such a way the location data of some other road 2 located under the location data of the road being traveled 1 is detected in the case where the processed location-specific road condition information 4 is searched for, and a guide message is prevented from being output in the case where the location-specific road condition information corresponding to some other road 2 having the same coordinates as the location data of some other road 2 is searched for.

Furthermore, the driving behavior of a driver, such as a sudden start, a sudden stop, sudden acceleration and sudden deceleration, are detected, and the driver receives a warning message, thus enabling the driver to safely drive the vehicle.

For this purpose, the control unit 370 manages a driving distance/speed detection module 380, and the location data of a vehicle input through the GPS reception unit 310 at one-second intervals is input to the driving distance/speed detection module 380.

The driving distance/speed detection module 380 measures the speed (km/h) of a vehicle using the coordinates of latitude and longitude that are the location data of the vehicle input at one-second intervals, converts the speed of the vehicle into a speed range by mapping the measured speed of the vehicle to the speed ranges of the table (refer to table 1), and determines where the speed range falls within any one of a low speed range (0 to 8), a middle speed range (9 to 22) and a high speed range (23 to 36).

TABLE 1

| Speed(km/h) | Speed range |
|---|---|
| 0-4.44 | 1 |
| 4.44-8.88 | 2 |
| 8.88-26.64 | 3 |
| 71.04-75.48 | 17 |
| 150.96-155.4 | 35 |
| 155.4-160 | 36 |

The driving distance/speed detection module 380 arranges speed ranges in groups of five successive speed ranges, and sequentially repeats a calculation in which a previous one of the grouped successive speed ranges is subtracted from a next one thereof. If the sum of the calculated values is larger than a corresponding critical speed value of the low speed range, the middle speed range or the high speed range, it is determined that the vehicle was suddenly started or accelerated. If the sum of the calculated values is smaller than a corresponding critical speed value of the low speed range, the middle speed range or the high speed range, it is determined that the vehicle was suddenly stopped or decelerated. Accordingly, a corresponding one of the warning messages, such as a sudden start, a sudden stop, sudden acceleration and sudden deceleration, stored in the memory unit 340 is controlled to be output.

For example, in the case where five successive speed ranges, which are determined to accelerate, displayed at one-second intervals are [3, 4, 6, 5, 8], a previous speed range 5 is subtracted from a next speed range 8. In such a manner, 5 (next speed range)−6 (previous speed range), . . . , 4 (next speed range)−3 (previous speed range) are calculated, and the calculated values [3, −1, 2, 1] are summed.

The driving distance/speed detection module 380 compares the absolute value of the sum with a corresponding critical speed value, and determines that the vehicle was suddenly accelerated if the absolute value of the sum is larger than a corresponding critical speed value. In this case, the critical speed values corresponding to the low speed range, the middle speed range and the high speed range are 4, 5.5 and 7, respectively. The five successive speed ranges [3, 4, 6, 5, 8] belong to the low speed range, so that the critical speed value thereof is 4.

Since the absolute value 5 of the sum is larger than the critical speed value of the low speed range, it is determined that the vehicle was suddenly accelerated, so that the driving distance/speed detection module 380 is controlled to output a sudden acceleration warning message, which is stored in the memory unit 340, through the message output unit 350, and continuously outputs the warning message to enable the driver to detect that the vehicle was suddenly accelerated, thus inducing the driving behavior of the driver to be changed so that the driver can safely drive the vehicle.

Furthermore, the mode button 363 is placed on the safe driving terminal 300 to allow the driver to selectively receive location-specific road condition information. The mode button 363 is located at ALL in the case where the driver desires to receive all location-specific road condition information, and the mode button 363 is located at CAM in the case where the driver desires to receive location-specific road condition information related to only speed detection cameras.

As described above, the present invention is effective in that the drivers of vehicles traveling on roads, on which unexpected conditions have occurred, inform other drivers of the types (contents) and locations of unexpected conditions during the unexpected conditions occur, thus enabling the drivers to safely drive the vehicles by detecting the unexpected conditions before encountering them even when the unexpected conditions occur.

Furthermore, even in the case where location-specific road condition information, which indicates a location to which a guide message for guiding the condition of a road is output, is indicated between a road being traveled, on which a corresponding vehicle is driven, and some other road, which is located near the road being traveled, the location is not misjudged, thus enabling the driver to safely drive the vehicle.

Furthermore, when the driver suddenly decelerates/stops or accelerates/starts the vehicle, the driver can be aware of such sudden deceleration/stop or acceleration/start, thus providing a safe driving guide in view of the driving behavior of the driver.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A safe driving guide system using a Global Positioning System (GPS), comprising:
a GPS satellite for transmitting location data of a vehicle;
a safe driving guide server for collecting location-specific road condition information that is renewed at regular intervals to allow a driver to safely drive the vehicle and location-specific road condition information that is directly registered by the driver, and integrating the two pieces of information into a single piece of location-specific road condition information, for providing processed location-specific road condition information corresponding to location-specific road condition information indicated between a road being traveled and some other road with reference to a driving direction of the vehicle so that operation errors are not generated in the case where the location-specific road condition information is indicated between the road being traveled and some other road at the time of driving the vehicle, and for providing a road condition guide message based on the location-specific road condition information; and
a safe driving guide terminal for receiving the location data from the GPS satellite, and for receiving standard location-specific road condition information, the processed location-specific road condition information and the road condition guide message from the safe driving guide server, and outputting the road condition guide message based on the location-specific road condition information at the time of driving the vehicle, the safe driving guide terminal including registration means for registering abnormal road conditions with the safe driving guide server in the case where the abnormal road conditions occur at the time of driving the vehicle.

2. The safe driving guide system as set forth in claim 1, wherein the safe driving guide server comprises a Data Base (DB) unit, the DB unit comprising:
a membership information DB for storing authentication information formed of an Identification (ID) and a password and personal information, which are registered by the driver of the vehicle;
an administrator-managed location-specific road condition information DB for storing location-specific road condition information that is road condition information and is formed of a message identification code corresponding to a guide message that indicates road conditions of a nation renewed at regular intervals and location data of a road to which the guide message indicating the road conditions is output;
a driver-registered location-specific road condition information DB for storing driver-registered location-specific road condition information that is road condition information directly registered by drivers and formed of a message identification code corresponding to a driver-registered location-specific road condition guide message and location data of the vehicle at the time of transmitting the location-specific road condition guide message;
a standard location-specific road condition information DB for storing standard location-specific road condition information that is formed by collecting and processing the administrator-managed location-specific road condition information and the driver-registered location-specific road condition information;
a processed location-specific road condition information DB for storing processed location-specific road condition information that is formed of location data of some other road and location data of the road being traveled corresponding to the location data of some other road in the case where location-specific road condition information is indicated on some other road, which is located near the road being traveled; and
a road condition guide message information DB for storing a road condition guide message that corresponds to the standard location-specific road condition information to allow the driver to safely drive the vehicle.

3. The safe driving guide system as set forth in claim 2, wherein the safe driving guide server comprises a collection/processing module for collecting the administrator-managed location-specific road condition information that is stored in the administrator-managed location-specific road condition information DB and the driver-registered location-specific road condition information that is stored in the driver-registered location-specific road condition information DB, and processing the condition information to the standard road related condition information.

4. The safe driving guide system as set forth in claim 2, wherein the safe driving guide terminal comprises:
a GPS reception unit for receiving the location data from the GPS satellite;
a data transmission and reception unit for receiving the standard location-specific road condition information, the processed location-specific road condition information and the road condition guide message, and for transmitting the driver-registered location-specific road condition information;
a memory unit for the standard location-specific road condition information, the processing location-specific road condition information and the road condition guide message input that are input through the data transmission and reception unit, and storing a location-specific road condition registration guide message that is a guide message required to allow the drivers to register the location-specific road condition with the guide server;
a message output unit for outputting the road condition guide message and the location-specific road condition registration guide message stored in the memory unit;
a data input unit for requesting an output of the location-specific road condition registration guide message stored in the memory unit, and selecting a corresponding one of a plurality of output location-specific road condition registration guide messages; and
a control unit for collecting a road condition display code input from the data input unit and coordinates (latitude and longitude) of the road on which the vehicle is located, and generating the driver-registered location-specific road condition information when the road condition display code is selected, and for controlling the generated driver-registered location-specific road condition information to be transmitted to the guide server through the data transmission and reception unit.

5. The safe driving guide system as set forth in claim 4, wherein the data transmission and reception unit is a wireless data transmission and reception unit for wirelessly transmitting and receiving the data.

6. The safe driving guide system as set forth in claim 4, wherein:
the data transmission and reception unit is a serial communication unit connecting with an Internet accessible Personal Computer (PC) to function as interface to allow the data to be uploaded or downloaded; and
the safe driving guide terminal includes a power supply unit for receiving an Alternating Current (AC) power of 220 V to supply power to the safe driving guide terminal through the power supply unit when the serial communication unit is connected to the Internet-accessible PC.

7. The safe driving guide system as set forth in claim 4, wherein:
the safe driving guide terminal includes a driving distance/speed detection module;
the memory unit includes messages warning of a sudden start, a sudden stop, sudden acceleration and sudden deceleration; and
the driving distance/sped detection module divides a range of 0 to 160 km/h into 36 speed ranges, classifies the 36 speed ranges in such a way that speed ranges 0 to 8 are set to a low speed range, speed ranges 9 to 22 are set to a middle speed range and speed ranges 23 to 36 are set to a high speed range, the low speed range, the middle speed range and the high speed range include a speed range table including critical speed values, converts the location data (latitude and longitude) of the vehicle, input through the GPS reception unit at regular intervals, into a speed (km/h), determines increases and decreases of converted successive speed values input at regular intervals, converts the converted successive speed values into speed ranges, arranges the speed ranges in groups of five successive speed ranges, sequentially repeats a calculation in which a previous speed range is subtracted from a next speed range, determines that the vehicle was suddenly started or accelerated if a sum of the calculated values is larger than a critical speed value corresponding to the low speed range, the middle speed range or the high speed range, determines that the vehicle was suddenly stopped or decelerated if the sum of the calculated values is smaller than the critical speed value corresponding to the low speed range, the middle speed range or the high speed range, and controls to allow a corresponding one of sudden start, sudden stop, sudden acceleration and sudden deceleration warning messages stored in the memory unit to be output.
